(19) United States
(12) Patent Application Publication
(10) Pub. No.: US 2008/0276527 A1
(43) Pub. Date: Nov. 13, 2008

(54) Plate-like soil-fixation plastic plate

(76) Inventor: Yi-Ting Huang, Taichung County (TW)

Correspondence Address: Yi-Ting, Huang, P.O.Box 44-2049, Taipei, 10668, TW

(21) Appl. No.: 11/798,203

(22) Filed: May 11, 2007

(51) Int. Cl. A01G 9/02

(52) U.S. Cl. 47/65.5

(57) ABSTRACT

A plate-like soil-fixation plastic plate is a rigid sheet-like body made of a weather-resistant composite plastic material and has a surface formed with several reinforcement ribs, which are integrally formed with the body in a crisscrossed manner to enhance the intensity of the plate. Two lateral sides of the plate are formed with several assembling holes. Four soil-fixation plastic plates of the invention may be assembled together using several connecting components to form a partitioning frame having open top and bottom ends to facilitate the planting.

### BACKGROUND OF THE INVENTION

(1) Field of the Invention

The invention relates to a plastic plate for farmland planting, and more particularly to a plate-like soil-fixation plastic plate, which has the good rigidity and is made of a weather-resistant composite plastic material. Many plate-like soil-fixation plastic plates may be assembled to form a farmland plant partitioning frame, which may be placed in the farmland to prevent the soil from hardening and being scoured away and to consolidate the soil and the manure and the nutriment stored therein, to keep the softness of the soil in the block and thus to enhance the effect of planting the root-based plant.

(2) Description of the Prior Art

Before a farmer plants the cropper, the farmer usually partitions the farmland into several longitudinal rectangular and convex blocks, and several concave passages between the blocks. That is, the farmland is partitioned into several levees to facilitate the planting management, fertilization and pesticide application. On the other hand, the water and the nutriment in the soil can be concentrated in the plant block to possibly make the plant absorb the water and the nutriment so that the better planting effect may be obtained. However, the convex soil is very soft and is gradually blown away, removed by the irrigation water, or being scoured by the rain. Thus, the convex soil tends to be scoured away or to harden to expose the root of the plant, and the applied manure and pesticide may also flow away to influence the growth of the plant.

### SUMMARY OF THE INVENTION

The invention provides a plate-like soil-fixation plastic plate, which is a rigid sheet-like body made of a weather-resistant composite plastic material and has a surface formed with several reinforcement ribs, which are integrally formed with the body in a crisscrossed manner to enhance the intensity of the plate. Two lateral sides of the plate are formed with several assembling holes. Four soil-fixation plastic plates of the invention may be assembled together using several connecting components to form a partitioning frame having open top and bottom ends to facilitate the planting. The partitioning frame is placed in the farmland to partition the farmland into several planting blocks to prevent the soil from hardening and being scoured away, and thus to consolidate the soil and the manure and the nutriment stored therein. Also, four partitioning frames may be directly erected to form a rectangle having four corners on which a net support may be placed to serve as an arbor for the climbing plant.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing an exterior of a plate-like soil-fixation plastic plate according to the invention.

FIG. 2 is a pictorially schematic illustration showing an exterior of an assembly constituted by four plate-like soil-fixation plastic plates according to the invention.

FIG. 3 is a pictorially exploded view showing the assembly of FIG. 2.

FIGS. 4 to 5 are schematic illustrations showing various assemblies, which are constituted by the plate-like soil-fixation plastic plates and have different specifications and shapes.

FIGS. 6 to 8 are schematic illustrations showing used states of assemblies, wherein the assemblies are constituted by the plate-like soil-fixation plastic plates and placed in the farmland.

### DETAILED DESCRIPTION OF THE PREFERRED EMBODIMENTS

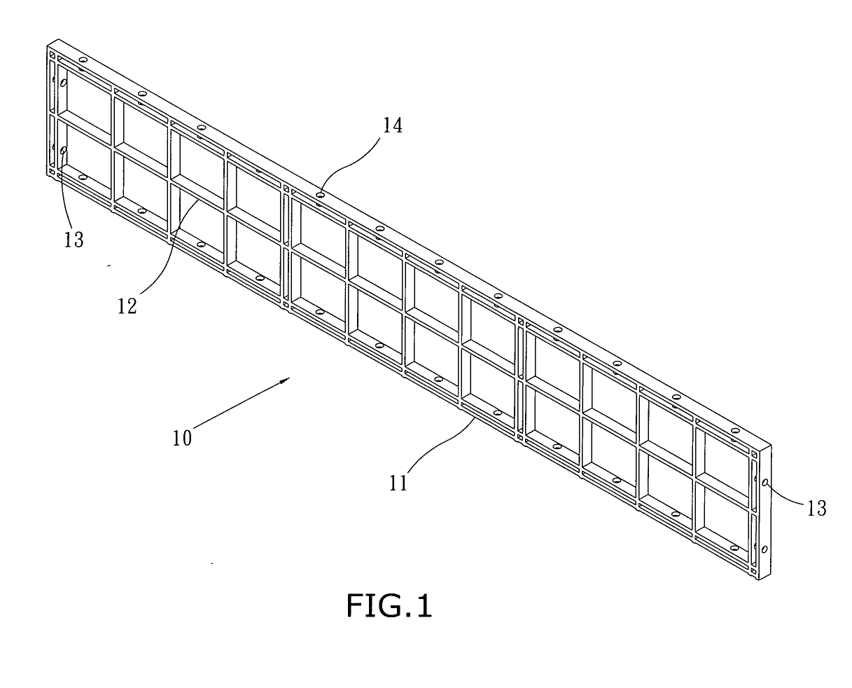

As shown in FIG. 1, a plate-like soil-fixation plastic plate 10 according to the invention is made of a weather-resistant composite plastic material, which has the good hardness to satisfy the requirement in the farmland. The weather-resistant composite plastic material may be adopted to form various plate-like bodies 11 having different lengths, widths and thicknesses. The plate-like body 11 may have a longitudinal rectangular shape or a rectangular shape. The inner surface of the body 11 has a smooth plane, and the outer surface of the body 11 is formed with several reinforcement ribs 12, which are arranged in a crisscrossed manner and integrally formed with the body 11 to enhance the intensity and the rigidity of the body 11. Two lateral sides of the body 11 are formed with several assembling holes 13 for the purpose of assembling. Several holes 14 are formed on a top end portion of the body 11 and will be described later.

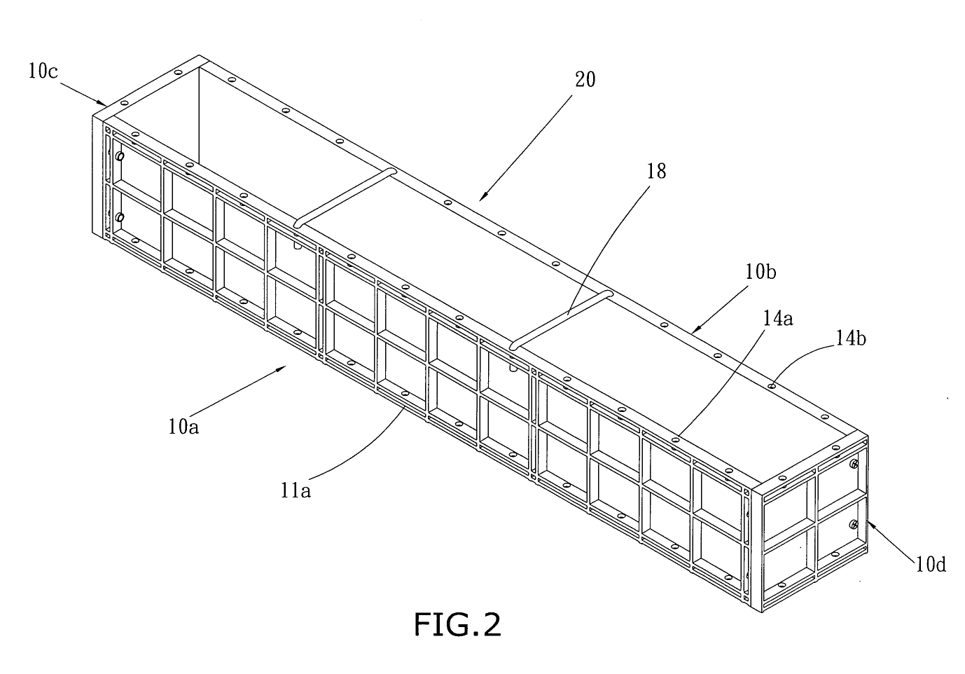

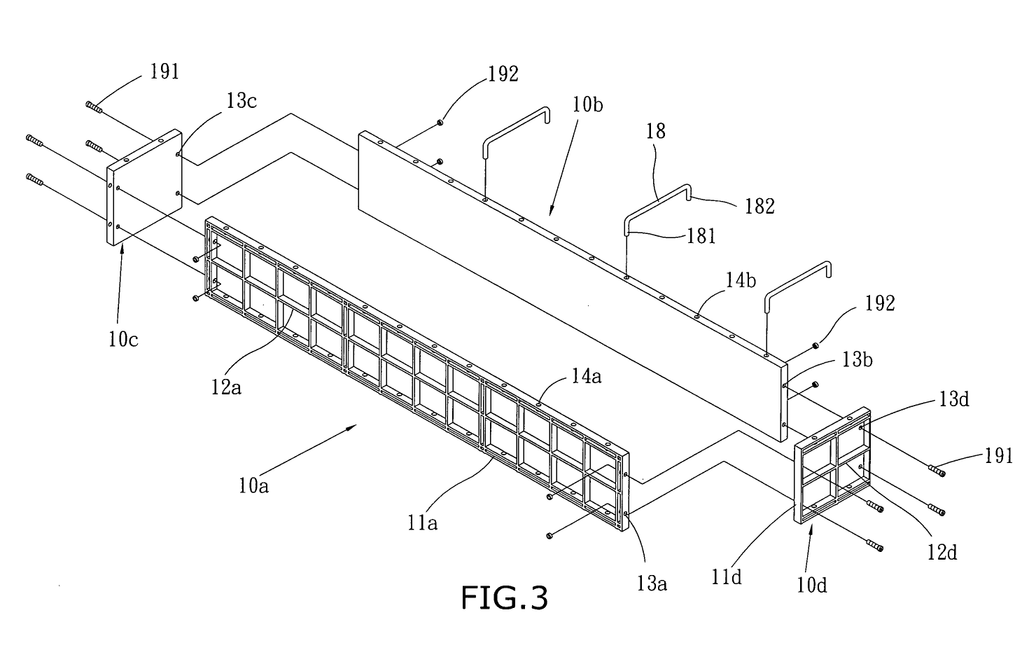

According to the plate-like soil-fixation plastic plate 10 of the invention, as shown in FIGS. 2 and 3, two plate-like soil-fixation plastic plates 10a and 10b both having longer lengths are arranged in parallel to form two long side portions of a rectangle, and two plate-like soil-fixation plastic plates 10c and 10d both having shorter lengths are arranged in parallel to form two short side portions of the rectangle and arranged at two ends of the plate-like soil-fixation plastic plates 10a and 10b to form the rectangle. Then, bolts 191 and nuts 192 corresponding to the assembling holes 13a, 13b, 13c and 13d formed on the bodies 11a to 11d of the plate-like soil-fixation plastic plates 10a to 10d are provided. The bolts 191 pass through the assembling holes 13a, 13b, 13c and 13d and are then screwed to the nuts 192, respectively, to assemble the bodies 11a to 11d into a frame-like assembly 20 having open top and bottom ends. The frame-like assembly 20 serves as the partitioning frame for farmland planting. Corresponding holes 14a and 14b are formed on a top end portion of the bodies 11a and 11b of the opposite plate-like soil-fixation plastic plates 10a and 10b of the assembly 20. Thus, two pins 181 and 182 of each inverse U-shape inserting rod 18 may be inserted into the holes 14a and 14b to reinforce the rigidity of the assembly 20 in order to prevent the assembly 20 from deforming due to the push of the soil.

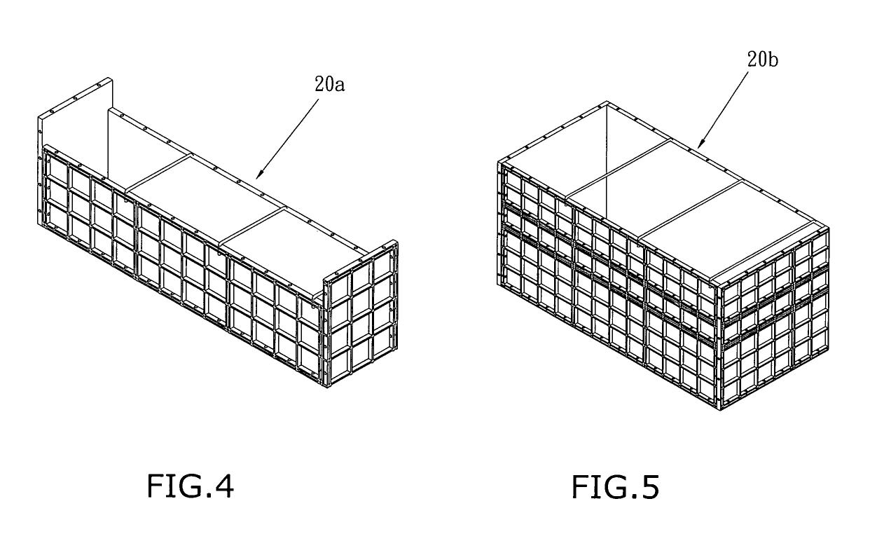

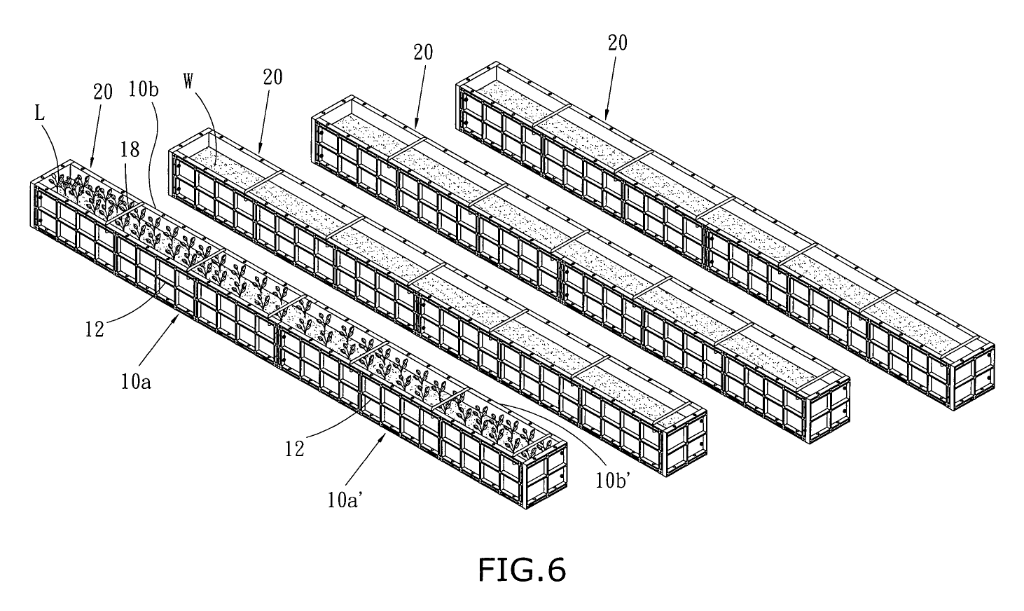

The frame-like assembly 20 may have a longitudinal rectangular shape, may be a longitudinal rectangular assembly 20a, or may be a rectangular assembly 20b, as shown in FIGS. 4 to 6. The assemblies 20 may be placed in the farmland with the top ends of the assemblies 20 being higher than the soil surface or being slightly flush with the soil surface. Thus, the farmland may be partitioned into several planting blocks to provide the better rigidity and endurance according to the material and the auxiliary reinforcement ribs 12 of the plate-like soil-fixation plastic plate 10 as well as the inserting rods 18 for positioning. Thus, the soil W in the assembly 20 (i.e., the plant partitioning frame) may be consolidated, and the manure and the nutriment applied to the soil cannot be scoured away by the water and are thus kept in the area defined by the plate-like soil-fixation plastic plates 10a to 10d. In the assembly 20, the manure and the nutriment may be completely absorbed by the plant L so that the effects of fertilization and pesticide spraying may be enhanced. Alternatively, many plate-like soil-fixation plastic plates 10 may be connected in series to form a predetermined length, as shown in FIG. 6, the longer rectangular assembly 20 is formed by two plate-like soil-fixation plastic plates 10a and 10a′ connected in series and two plate-like soil-fixation plastic plates 10b and 10b′ connected in series and arranged in parallel to the plate-like soil-fixation plastic plates 10a and 10a′. The assembly (i.e., the plant partitioning frame) 20 may partition the farmland into different planting blocks so that different soil areas with different conditions (e.g., different water contents, different soil components or nutriments) may be formed in the same farmland. Thus, different kinds of plants or croppers may be planted in the different soil areas according to the different water contents of the irrigation, the different manure of the nutriment, and the pesticide with the different components so that the croppers in the farmland may have diversified properties, the investment risk may be dispersed and the farmland often has the cropper to be harvested, and the economical effectiveness may be enhanced. Thus, it is unnecessary to worry about the conditions of the water contents and the soil in the same farmland and to plant only one kinds of cropper.

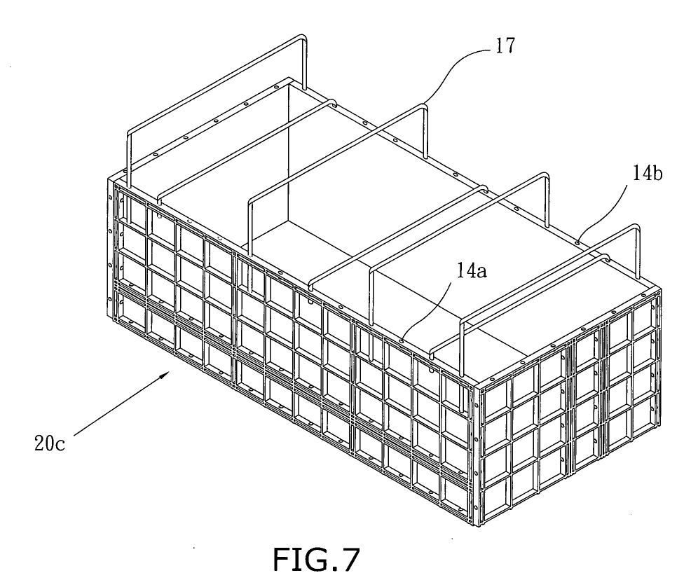

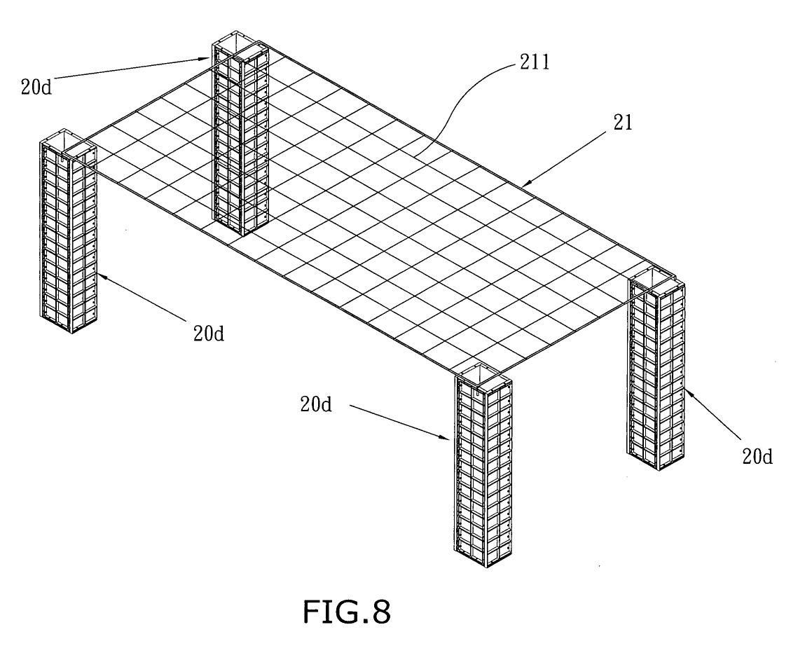

Furthermore, as shown in FIG. 7, the frame-like assembly 20c constituted by the plate-like soil-fixation plastic plate 10 of the invention may have several holes 14a and 14b. Several inverse U-shaped net supports 17 may be inserted into the holes 14a and 14b to support a net above the assembly 20c to prevent the insect pest. The cropper can be easily harvested by disassembling the plate-like soil-fixation plastic plates 10. Alternatively, four longer plate-like soil-fixation plastic plates may constitute an assembly 20d, and a C-type lightweight steel arbor 21 wound with the ferrite-plated metal wire mesh 211 may be disposed on the four assemblies 20d, as shown in FIG. 8. Thus, it is possible to prevent the drawbacks caused in the prior art, in which the arbor structure has wood rods, which are established on the cement blocks and tend to be decayed, broken and separated from the cement blocks to break the arbor and make the arbor tumble.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A plate-like soil-fixation plastic plate, which is a rigid sheet-like body made of a weather-resistant composite plastic material, characterized in that the rigid sheet-like body has:
a surface formed with a plurality of reinforcement ribs, which is integrally formed with the rigid sheet-like body in a crisscrossed manner to enhance an intensity of the rigid sheet-like body;
two lateral sides formed with a plurality of assembling holes; and
a top end portion formed with a plurality of holes.
